(19) United States
(12) Patent Application Publication
(10) Pub. No.: US 2015/0239022 A1
(43) Pub. Date: Aug. 27, 2015

(54) STRUCTURE HAVING ANTIFOULING PROPERTIES AND HAVING CONCAVE-CONVEX SHAPED SURFACE, AND METHOD FOR PRODUCING THE SAME

(71) Applicant: NISSAN CHEMICAL INDUSTRIES, LTD., Tokyo (JP)

(72) Inventors: Junpei Kobayashi, Funabashi-shi (JP); Taku Kato, Funabashi-shi (JP); Masayoshi Suzuki, Funabashi-shi (JP)

(21) Appl. No.: 14/415,973

(22) PCT Filed: Jul. 10, 2013
(86) PCT No.: PCT/JP2013/068876

§ 371 Date: Jan. 20, 2015

(30) Foreign Application Priority Data
Jul. 19, 2012 (JP) 2012-160414

(51) Int. Cl. B08B 17/06; B29C 59/16

(52) U.S. Cl. CPC B08B 17/06; B29C 59/16; B29K 2083/00

(57) ABSTRACT

A structure having dry-wiping off characteristic relative to dirt attached to a concave-convex shaped surface of the structure, and a method for producing the structure. A structure having a concave-convex shaped surface, fabricated from a composition containing at least one compound having in a molecule, one to ten polymerizable group(s) and a photopolymerization initiator, wherein the structure has a Martens hardness of 3 N/mm² or more and 130 N/mm² or less when the Martens hardness of the structure is measured under a condition under which a Martens hardness of a molten quartz is 4,100 N/mm². The structure is produced by applying the composition onto a substrate; pressing a coating film on the substrate into a concave-convex shaped face of a mold; photocuring the coating film while it is pressed into the concave-convex shaped face of the mold; and peeling the cured film on the substrate from the mold.

### TECHNICAL FIELD

The present invention relates to a structure that is fabricated from an imprint material (film forming composition for imprint), has a Martens hardness within a specified range, and has a concave-convex shaped surface, and to a method for producing the same. In more detail, the present invention relates to a structure having the above-described surface in which dirt such as fingerprints attached to the concave-convex shaped surface of the structure can be easily wiped off, and a method for producing the same.

### BACKGROUND ART

In 1995, Professor Chow et. al. serving at present in Princeton University proposed a novel technology called nanoimprint lithography (Patent Document 1). Nanoimprint lithography is a technology to form an objective pattern on a cured resin film by a method including: bringing a mold having any pattern into contact with a substrate on which a resin film is formed, pressurizing the resin film, and applying heat or light as an external stimulation to the resin film. Nanoimprint lithography has such an advantage that the processing in a nanometer scale can be performed more easily and more inexpensively than by optical lithography used in a conventional production of semiconductor devices.

Accordingly, nanoimprint lithography is a technology expected to be applied to the production of a semiconductor device, an optodevice, a display, a storage medium, a biochip, or the like in place of the optical lithography technology. Various reports have been disclosed with respect to a curable composition for optical nanoimprint lithography used for nanoimprint lithography (Patent Document 2 and Patent Document 3).

For electronic equipment such as an optodevice and a display, performance to enable dirt such as fingerprints attached to the surface thereof to be removed is required. It is desired that when dirt is wiped off the electronic equipment, the dirt be dry-wiped off the electronic equipment without using a cleaning liquid such as water, in terms of handling the electronic equipment. Various structures having a concave-convex shaped surface, which can be obtained by nanoimprint lithography, have been disclosed. However, in the above-described documents, a study for or a report of removing dirt such as fingerprints attached to the above-described structure by directly dry-wiping with a cloth, has not been made.

### PRIOR ART DOCUMENTS

### Patent Documents

Patent Document 1: U.S. Pat. No. 5,772,905 Specification

Patent Document 2: Japanese Patent Application Publication No. 2008-105414 (JP 2008-105414 A)

Patent Document 3: Japanese Patent Application Publication No. 2008-202022 (JP 2008-202022 A)

### SUMMARY OF THE INVENTION

### Problems to be Solved by the Invention

The present invention has been invented according to the above-described circumstances and it is an object of the present invention to provide a structure having dry-wiping off characteristic relative to dirt such as fingerprints attached to a concave-convex shaped surface of the structure, and a method for producing the same.

### Means for Solving the Problems

As a result of intensive studies for solving the above-described problems, the inventors of the present invention have found that by producing a structure having a concave-convex shaped surface and hardness that is within a specified range, wiping-off properties relative to fingerprints attached to the surface of the above-described structure are developed in the above-described structure. Thus, the present invention has now been completed.

Specifically, the present invention relates to, according to a first aspect, a structure having a concave-convex shaped surface, fabricated from a composition containing at least one compound having in a molecule, one to ten polymerizable group(s) and a photopolymerization initiator, in which the structure has a Martens hardness of 3 N/mm² or more and 130 N/mm² or less when the Martens hardness of the structure is measured under a condition under which a Martens hardness of a molten quartz is 4,100 N/mm².

The present invention relates to, according to a second aspect, the structure according to the first aspect, in which the polymerizable group is at least one selected from the group consisting of an acryloyloxy group, a methacryloyloxy group, a vinyl group, and an allyl group.

The present invention relates to, according to a third aspect, the structure according to the first aspect or the second aspect, fabricated by imprinting the composition further containing a silicone compound.

The present invention relates to, according to a fourth aspect, the structure according to the third aspect, in which the silicone compound is a compound of Formula (1) or Formula (2):

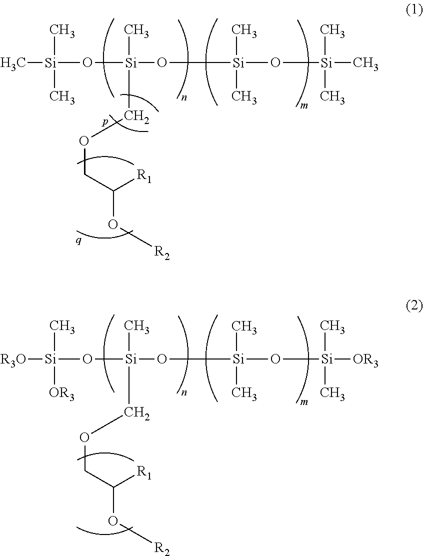

(in Formulae (1) and (2), R₁ is a hydrogen atom or a methyl group; R₂ is a hydrogen atom or a C₁₋₅ alkyl group; a plurality of R₃s are each independently a hydrogen atom or a C₁₋₃ alkyl group; n is an integer of 1 to 55; m is an integer of 0 to 97; p is an integer of 1 to 5; and q is an integer of 1 to 10).

The present invention relates to, according to a fifth aspect, the structure according to any one of the first aspect to the fourth aspect, in which the concave-convex shape is a moth-eye structure.

The present invention relates to, according to a sixth aspect, a method for producing the structure as described in any one of the first aspect to the fifth aspect, comprising: applying the composition containing at least one compound having in a molecule, one to ten polymerizable group(s) and a photopolymerization initiator onto a substrate; pressing a coating film on the substrate into a concave-convex shaped face of a mold; photocuring the coating film while it is pressed into the concave-convex shaped face of the mold; and peeling the cured film on the substrate from the mold.

The present invention relates to, according to a seventh aspect, the method for producing the structure according to the sixth aspect, in which the composition further contains a surfactant.

The present invention relates to, according to an eighth aspect, the method for producing the structure according to the sixth aspect or the seventh aspect, comprising: applying the composition further containing a solvent onto the substrate and then baking the composition to evaporate the solvent.

The present invention relates to, according to a ninth aspect, the method for producing the structure according to any one of the sixth aspect to the eighth aspect, in which as the substrate, a film is used, and in a test in which the cured film on the film is peeled from the mold at 90°, a mold release force that is a value obtained by converting a load applied to the cured film on the film when the cured film is peeled from the mold into a load per cm of the width of the film, is larger than 0 g/cm and 0.7 g/cm or smaller.

The present invention relates to, according to a tenth aspect, an optical member comprising: the structure as described in any one of the first aspect to the fifth aspect on a substrate.

The present invention relates to, according to an eleventh aspect, a solid-state imaging device comprising: the structure as described in any one of the first aspect to the fifth aspect on a substrate.

The present invention relates to, according to a twelfth aspect, an LED device comprising: the structure as described in any one of the first aspect to the fifth aspect on a substrate.

The present invention relates to, according to a thirteenth aspect, a semiconductor device comprising: the structure as described in any one of the first aspect to the fifth aspect on a substrate.

The present invention relates to, according to a fourteenth aspect, a solar battery comprising: the structure as described in any one of the first aspect to the fifth aspect on a substrate.

The present invention relates to, according to a fifteenth aspect, a display comprising: the structure as described in any one of the first aspect to the fifth aspect on a substrate.

The present invention relates to, according to a sixteenth aspect, an electronic device comprising: the structure as described in any one of the first aspect to the fifth aspect on a substrate.

### Effects of the Invention

Dirt such as fingerprints attached to the concave-convex shaped surface of the structure of the present invention can be dry-wiped off. Accordingly, the structure of the present invention can be suitably applied to products such as a solar battery, a LED device, and a display using a member for which dirt wiping-off properties relative to dirt such as fingerprints are required.

### MODES FOR CARRYING OUT THE INVENTION

<Shape of Structure>

In the structure of the present invention, a convex portion represents a portion protruding from a reference level and a concave portion represents a portion recessed from a reference level. The structure of the present invention may have either both of the convex portion and the concave portion, or only either one of the convex portion and the concave portion. When the structure of the present invention is used as an anti-reflective coating of a device, the structure has a surface preferably in a moth-eye shape. Here, the moth-eye shape represents a shape in which a concave portion and a convex portion are repeated continuously to form a wavy shape.

With respect to the concave-convex shape of the surface of the structure of the present invention, although the dimensions thereof are not particularly limited, the aspect ratio thereof is, for example, 1.0 or larger and 3.0 or smaller, preferably 1.0 or larger and 1.5 or smaller. Here, the aspect ratio represents (an average height of the convex portion from the reference level or an average depth of the concave portion from the reference level)/(an average cycle of the convex portion or the concave portion with regard to at least one direction).

Although examples of a mold material for the optical imprint used for the production of the structure of the present invention include quartz, silicon, nickel, alumina, a carbonyl silane, and glassy carbon, the mold material used in the present invention is not particularly limited so long as an objective pattern can be obtained. In addition, to improve the mold release properties, the mold may be subjected to a mold release treatment for forming a thin film of a fluorine-based compound or the like on the surface of the mold. Although examples of the mold release agent used for the mold release treatment include OPTOOL (registered trademark) HD and DSX manufactured by DAIKIN INDUSTRIES, Ltd., the mold release agent is not particularly limited so long as an objective pattern can be obtained.

The size of the pattern obtained by the optical imprint is a size in a nanometer order and corresponds specifically to a pattern size of smaller than 1 micron.

The composition (imprint material) containing at least one compound having in a molecule thereof, one to ten polymerizable group(s) and a photopolymerization initiator is used for the production of the structure of the present invention. Methods for applying such composition onto a substrate include publicly known or well-known methods such as a spin coating method, a dipping method, a flow coating method, an inkjet method, a spraying method, a bar coating method, a gravure coating method, a slit coating method, a roll coating method, a transfer printing method, a brush coating method, a blade coating method, and an air knife coating method.

Examples of the substrate onto which the above-described imprint material used for the production of the structure of the present invention is applied include substrates containing a silicon, a glass on which indium tin oxide (ITO) is film-formed (hereinafter, abbreviated as “ITO substrate” in the present specification), a glass on which silicon nitride (SiN) is film-formed (SiN substrate), a glass on which indium zinc oxide (IZO) is film-formed, polyethylene terephthalate (PET), triacetylcellulose (TAC), an acryl, a plastic, a glass, a quartz, or a ceramic. In addition, substrates that can be also used include flexible substrates having flexibility such as substrates containing triacetylcellulose, polyethylene terephthalate, methyl polymethacrylate, a cycloolefin (co)polymer, polyvinyl alcohol, polycarbonate, polystyrene, polyimide, polyamide, polyolefin, polypropylene, polyethylene, polyethylene naphthalate, polyethersulfone, and a copolymer produced from a combination of the above polymers.

The light source for curing the above-described imprint material after being applied onto the substrate is not particularly limited and examples thereof include a high pressure mercury lamp, a low pressure mercury lamp, an electrodeless lamp, a metal halide lamp, a KrF excimer laser, an ArF excimer laser, a F₂ excimer laser, an electron beam (EB), and extreme ultraviolet rays (EUV). With respect to the wavelength, generally, a G line of 436 nm, an H line of 405 nm, an I line of 365 nm, or a GHI mixed line can be used. The exposure amount is preferably 30 mJ/cm² to 2,000 mJ/cm² and more preferably 30 mJ/cm² to 1,000 mJ/cm².

When the imprint material contains a solvent, at least one of the coating film before the irradiation with light and the cured film after the irradiation with light may be subjected to a baking process as an additional process for the purpose of evaporating the solvent. The apparatus for baking the coating film is not particularly limited and may be any apparatus capable of baking the coating film in an appropriate atmosphere, that is, in the air, in an inert gas such as nitrogen, or in vacuum with, for example, a hot plate, an oven, or a furnace. Although the baking temperature is, for the purpose of evaporating the solvent, not particularly limited, the baking can be performed, for example, at 40° C. to 200° C.

Although the apparatus for performing the optical imprint is not particularly limited so long as an objective structure can be obtained, examples thereof include commercially available apparatuses such as ST50 and ST50S-LED manufactured by Toshiba Machine Co., Ltd., Sindre (registered trademark) 60 manufactured by Obducat AB, and NM-0801HB manufactured by Meisyo Kiko Co., Ltd. Then, there can be used a method in which by using the apparatus, the imprint material applied onto the substrate is pressed into the mold and after photocuring the coating film, the cured coating film is mold-released.

<Martens Hardness>

It is imperative that the structure of the present invention have a Martens hardness measured by the nano indentation of 3 N/mm² or more, preferably 8 N/mm² or more and 130 N/mm² or less when the Martens hardness of the structure is measured under a condition under which the Martens hardness of a molten quartz is 4,100 N/mm². When the Martens hardness of the structure is less than 8 N/mm², the formation of the structure by the optical imprint becomes difficult. When the Martens hardness of the structure is more than 130 N/mm², destruction of the structure is likely to occur upon wiping off fingerprints attached to the concave-convex shaped surface of the structure. The Martens hardness is measured using as the measuring apparatus, an ultramicro indentation hardness tester ENT-2100 (manufactured by ELIONIX INC.) and using as the indenter, a titanium triangular indenter (manufactured by Tokyo Diamond Tools Mfg. Co., Ltd.) having an intercristal angle of 115°.

<Mold Release Force>

The 90° peeling test for evaluating the mold release force in the present specification refers to a test in which, generally an adhering material (corresponding to the cured film formed by the optical imprint in the present invention) adheres to an adherend (corresponding to the film used as the substrate in the present invention) and after a specified time, a resistance force (tension) generated when peeling the adhering material from the adherend with a specified peeling rate in a 90° direction is measured. Usually, the measurement is performed by an evaluation method referring to JIS Z0237. A value obtained by converting the resistance force measured here into that per a width of the adherend can be evaluated as the mold release force. In the present invention, the composition containing at least one compound having in a molecule thereof, one to ten polymerizable group(s) and a photopolymerization initiator is applied onto a film and the resultant coating film is adhering to the concave-convex shaped face of the mold. Then, while it is still adhering to the concave-convex shaped face of the mold, the coating film is photocured. The mold release force is measured in a test in which the cured coating film is peeled from the concave-convex shaped face of the mold in a 90° direction. The smaller the mold release force measured in the test described above is, that is, the smaller the value obtained by converting a load applied to the cured film when the cured film is completely peeled from the concave-convex shaped face of the mold into a load per cm of the width of the film is, the more preferred it is. The mold release force is preferably, for example, larger than 0 g/cm and 0.7 g/cm or smaller.

<Imprint Material for Forming Structure>

Hereinafter, the imprint material (composition) for forming the structure of the present invention is described in detail.

<Compound Having in Molecule Thereof, One to Ten Polymerizable Group(s)>

The compound having in a molecule thereof, one to ten polymerizable group(s) may be used individually or in combination of two or more types thereof so long as a desired hardness of the structure can be obtained. The compound may have in a molecule thereof, an ester bond, an ether bond, or a urethane bond. Examples of the polymerizable group include an acryloyloxy group, a methacryloyloxy group, a vinyl group, and an allyl group. Here, the acryloyloxy group may be expressed as an acryloxy group and a methacryloyloxy group may be expressed as a methacryloxy group.

Examples of the above-described compound include methyl(meth)acrylate, ethyl(meth)acrylate, n-butyl(meth)acrylate, isobutyl(meth)acrylate, tert-butyl(meth)acrylate, 2-ethylhexyl(meth)acrylate, isodecyl(meth)acrylate, n-lauryl(meth)acrylate, n-stearyl(meth)acrylate, isostearyl(meth)acrylate, n-butoxyethyl(meth)acrylate, butoxydiethylene glycol(meth)acrylate, cyclohexyl(meth)acrylate, tetrahydrofurfuryl(meth)acrylate, benzyl(meth)acrylate, phenoxyethyl(meth)acrylate, isobornyl(meth)acrylate, 2-hydroxyethyl(meth)acrylate, 2-hydroxypropyl(meth)acrylate, 2-hydroxybutyl(meth)acrylate, dimethylaminoethyl(meth)acrylate, diethylaminoethyl(meth)acrylate, (meth)acrylic acid, 2-(meth)acryloyloxyethylsuccinic acid, 2-methacryloyloxyethylhexahydrophthalic acid, 2-methacryloyloxyethyl-2-hydroxypropyl phthalate, glycidyl(meth)acrylate, 2-methacryloyloxyethyl acid phosphate, methoxypolyethylene glycol(meth)acrylate, phenoxypolyethylene glycol(meth)acrylate, hydroxyethylated o-phenylphenol acrylate, o-phenylphenol glycidyl ether acrylate, neopentyl glycol di(meth)acrylate, 2-hydroxypropanediol di(meth)acrylate, 2-hydroxy-3-acryloyloxypropyl methacrylate, isopropylene glycol di(meth)acrylate, ethoxylated bisphenol A di(meth)acrylate, tricyclodecane dimethanol di(meth)acrylate, 1,6-hexanediol di(meth)acrylate, 1,9-nonanediol di(meth)acrylate, 1,10-decanediol di(meth)acrylate, ethylene glycol di(meth)acrylate, diethylene glycol di(meth)acrylate, polyethylene glycol di(meth)acrylate, polytetramethylene glycol #650 di(meth)acrylate, polypropylene glycol di(meth)acrylate, dioxane glycol di(meth)acrylate, ethylene oxide-propylene oxide copolymer di(meth)acrylic acid ester, ethoxylated polypropylene glycol #700 di(meth)acrylate, bisphenoxyethanolfluorene dimethacrylate, pentaerythritol triacrylate, trimethylolpropane tri(meth)acrylate, ethoxylated trimethylolpropane triacrylate, ethoxylated glycerin triacrylate, ethoxylated isocyanuric acid triacrylate, s-caprolactone-modified tris-(2-acryloxyethyl) isocyanurate, pentaerythritol tetraacrylate, ethoxylated pentaerythritol tetraacrylate, ditrimethylolpropane tetraacrylate, dipentaerythritol hexaacrylate, ethoxylated dipentaerythritol hexaacrylate, dipentaerythritol polyacrylate, polyglycerinmonoethylene oxide polyacrylate, polyglycerin polyethylene glycol polyacrylate, pentaerythritol triacrylate hexamethylene diisocyanate urethane prepolymer, pentaerythritol triacrylate toluene diisocyanate urethane prepolymer, pentaerythritol triacrylate isophorone diisocyanate urethane prepolymer, and dipentaerythritol pentaacrylate hexamethylene diisocyanate urethane prepolymer. In the present specification, (meth)acrylate refers to both of an acrylate compound and a methacrylate compound.

The above-described compound is commercially available and specific examples of the commercially available product include: light ester M, E, NB, IB, TB, EH, ID, L, S, BC, 130MA, 041MA, CH, THF(1000), BZ, PO, IB-X, HO-225(N), HOP(N), HOA(N), HOP-A(N), HOB(N), DM, DE, A, HOMS(N), HO-HH(N), HO-MPP(N), G, P-1M, G-101P, G-201P, EG; UA-306H, UA-306T, UA-306I, and UA-510H (manufactured by KYOEISHA CHEMICAL Co., LTD.); NK ester AM-30G, AM-90G, AM-130G, AM-230G, M-20G, M-40G, M-90G, TM230G, AMP-10G, AMP-20GY, AMP-60G, PHE-1G, A-LEN-10, 401P, S1800A, A-SA, SA, 701A, 701, ABE300, A-BPE-4, A-BPE-6, A-BPE-10, A-BPE-20, A-BPE-30, BPE-80N, BPE-100N, BPE-200, BPE-500, BPE-900, BPE-1300N, A-DCP, DCP, A-200, A-400, A-600, A-1000, 1G, 2G, 3G, 4G, 9G, 14G, 23G, A-PTMG65, APG-100, APG-200, APG-400, APG-700, 3PG, 9PG, A-DOG, A-HD-N, HD-N, A-NOD-N, NOD-N, A-DOD, DOD-N, A-TMM-3LMN, A-TMPT, TMPT, A-TMPT-3EO, A-GLY-3E, A-GLY-9E, A-GLY-20E, A-9300, A-9300-1CL, A-9300-6CL, A-TMMT, ATM-4E, ATM-35E, AD-TMP, A-DPH, A-DPH-12E, A-9550, A-9530, ADP-51EH, and ATM-31EH; NK economer A-1000PER, A-PG5009E, A-PG5027E, A-PG5054E; UA-W2A, UA-W2, UA-7000, UA-7100, UA-7200, U-108A, UA-2235-PEUA-4200, U-2PPA, U-6HA, UA-32P, and U-324A (manufactured by Shin Nakamura Chemical Co., Ltd.); KAYARAD (registered trademark) NPGDA, R-712, R-604, R-684, T-1420, D-330, D-310, DPCA-20, DPCA-30, DPCA-60, DPCA-120, GPO-303, TMPTA, THE-330, TPA-320, TPA-330, PET-30, RP-1040, DPHA, DPHA-2C, DN-0075, DN-2475, and DPEA-12 (manufactured by Nippon Kayaku Co., Ltd.); FANCRYL (registered trademark) FA-P240A, FA-P270A, and FA-023M (manufactured by Hitachi Chemical Co., Ltd.); and OGSOL (registered trademark) EA-0200 (manufactured by Osaka Gas Chemicals).

<Photopolymerization Initiator>

Although the photopolymerization initiator is not particularly limited so long as the photopolymerization initiator has absorption relative to light from a light source used for the photocuring, examples thereof include: organic peroxides such as tert-butylperoxy-isobutarate, 2,5-dimethyl-2,5-bis(benzoyldioxy)hexane, 1,4-bis[α-(tert-butyldioxy)-isopropoxy]benzene, di-tert-butyl peroxide, 2,5-dimethyl-2,5-bis(tert-butyldioxy)hexene hydroperoxide, α-(isopropylphenyl)-isopropyl hydroperoxide, tert-butyl hydroperoxide, 1,1-bis(tert-butyldioxy)-3,3,5-trimethylcyclohexane, butyl-4,4-bis(tert-butyldioxy) valerate, cyclohexanone peroxide, 2,2′,5,5′-tetra(tert-butylperoxycarbonyl)benzophenone, 3,3′,4,4′-tetra(tert-butylperoxycarbonyl)benzophenone, 3,3′,4,4′-tetra(tert-amylperoxycarbonyl)benzophenone, 3,3′,4,4′-tetra(tert-hexylperoxycarbonyl)benzophenone, 3,3′-bis(tert-butylperoxycarbonyl)-4,4′-dicarboxy benzophenone, tert-butylperoxy benzoate, and di-tert-butyldiperoxy isophthalate; quinones such as 9,10-anthraquinone, 1-chloroanthraquinone, 2-chloroanthraquinone, octamethylanthraquinone, and 1,2-benzanthraquinone; benzoin derivatives such as benzoin methyl, benzoin ethyl ether, α-methylbenzoin, and α-phenylbenzoin; alkylphenone-based compounds such as 2,2-dimethoxy-1,2-diphenylethan-1-one, 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-[4-{4-(2-hydroxy-2-methyl-propionyl)benzyl}-phenyl]-2-methyl-propan-1-one, phenylglyoxylic acid methyl ester, 2-methyl-1-[4-(methylthio)phenyl]-2-morpholino propan-1-one, and 2-benzyl-2-dimethylamino-1-(4-morpholinophenyl)-butanone-1,2-dimethylamino-2-(4-m ethyl-benzyl)-1-(4-morpholin-4-yl-phenyl)-butan-1-one; acylphosphine oxide-based compound such as bis(2,4,6-trimethylbenzoil)-phenyl phosphineoxide, and 2,4,6-trimethylbenzoil-diphenyl-phosphineoxide; and oxime ester-based compounds such as 1,2-octanedione, 1-[4-(phenylthio)-, 2-(O-benzoyloxime)], and ethanone, 1-[9-ethyl-6-(2-methylbenzoyl)-9H-carbazol-3-yl]-, 1-(O-acetyloxime).

The above-described compound is commercially available and specific examples of the commercially available product include: IRGACURE (registered trademark) 651, 184, 500, 2959, 127, 754, 907, 369, 379, 379EG, 819, 819DW, 1800, 1870, 784, OXE01, OXE02, 250; Darocur (registered trademark) 1173, MBF, 4265; Lucirin (registered trademark) TPO (manufactured by BASF Japan Ltd.); KAYACURE (registered trademark) DETX, MBP, DMBI, EPA, and OA (manufactured by Nippon Kayaku Co., Ltd.); VICURE-10, and VICURE-55, (manufactured by STAUFFER Co., LTD.); ESACURE (registered trademark) KIP150, TZT, 1001, KTO46, KB1, KL200, KS300, EB3; triazine-PMS, triazine A, and triazine B (Nihon Siebel Hegner K.K of Japan); and ADEKA OPTOMER-N-1717, ADEKA OPTOMER-N-1414, and ADEKA OPTOMER-N-1606 (manufactured by ADEKA CORPORATION).

These photopolymerization initiators may be used individually or in combination of two or more types thereof.

<Silicone Compound>

The silicone compound contributes to lowering the mold release force measured when the resin film is completely peeled from the mold. The silicone compound refers to a compound having in a molecule thereof, a silicone skeleton (siloxane skeleton), is preferably a compound having a dimethylsilicone skeleton, and is particularly preferably a compound of Formula (1) or Formula (2).

The above-described compound is commercially available and specific examples of the commercially available product include: BYK-302, BYK-307, BYK-322, BYK-323, BYK-330, BYK-333, BYK-370, BYK-375, BYK-378, BYK-UV 3500, and BYK-UV 3570 (manufactured by BYK Japan KK); and X-22-164, X-22-164AS, X-22-164A, X-22-164B, X-22-164C, X-22-164E, X-22-163, X-22-169AS, X-22-174DX, X-22-2426, X-22-9002, X-22-2475, X-22-4952, KF-643, X-22-343, X-22-2404, X-22-2046, and X-22-1602 (Shin-Etsu Chemical Co., Ltd.).

These compounds having a silicone skeleton may be used individually or in combination of two or more types thereof.

<Surfactant>

In the imprint material for forming the structure of the present invention, a surfactant may be blended. The surfactant carries out a task of controlling the film-forming properties of the obtained coating film.

Examples of the surfactant include: nonionic surfactants, for example, polyoxyethylene alkyl ethers such as polyoxyethylene lauryl ether, polyoxyethylene stearyl ether, polyoxyethylene cetyl ether, and polyoxyethylene oleyl ether, polyoxyethylene alkylaryl ethers such as polyoxyethylene octylphenyl ether and polyoxyethylene nonylphenyl ether, polyoxyethylene/polyoxypropylene block copolymers, sorbitan fatty acid esters such as sorbitan monolaurate, sorbitan monopalmitate, sorbitan monostearate, sorbitan monooleate, sorbitan trioleate, and sorbitan tristearate, polyoxyethylene sorbitan fatty acid esters such as polyoxyethylene sorbitan monolaurate, polyoxyethylene sorbitan monopalmitate, polyoxyethylene sorbitan monostearate, polyoxyethylene sorbitan trioleate, and polyoxyethylene sorbitan tristearate; fluorinated surfactants, for example, EFTOP (registered trademark) EF301, EF303, and EF352 (trade name; manufactured by Mitsubishi Materials Electronic Chemicals Co., Ltd. (ex.: Gemco Co., Ltd.)), MEGAFAC (registered trademark) F171, F553, F554, F477, F173, R-08, and R-30 (trade name; manufactured by DIC Corporation), Fluorad FC430 and FC431 (trade name; manufactured by Sumitomo 3M Limited), AsahiGuard (registered trademark) AG710 and Surflon (registered trademark) S-382, SC101, SC102, SC103, SC104, SC105, and SC106 (trade name; manufactured by Asahi Glass Co., Ltd.); and Organosiloxane polymer KP341 (manufactured by Shin-Etsu Chemical Co., Ltd.).

These surfactants may be used individually or in combination of two or more types thereof. When the surfactant is used, the content thereof is preferably 0.01 phr to 40 phr and more preferably 0.01 phr to 10 phr, based on the mass of the compound having in a molecule thereof, one to ten polymerizable group(s).

<Solvent>

The imprint material for forming the structure of the present invention may contain a solvent. The solvent carries out a task of controlling the film thickness of the obtained structure.

Examples of the solvent include toluene, p-xylene, o-xylene, styrene, ethylene glycol dimethyl ether, propylene glycol monomethyl ether, ethylene glycol monomethyl ether, propylene glycol monoethyl ether, ethylene glycol monoethyl ether, ethylene glycol monoisopropyl ether, ethylene glycol methyl ether acetate, propylene glycol monomethyl ether acetate, ethylene glycol ethyl ether acetate, diethylene glycol dimethyl ether, propylene glycol monobutyl ether, ethylene glycol monobutyl ether, diethylene glycol diethyl ether, dipropylene glycol monomethyl ether, diethylene glycol monomethyl ether, dipropylene glycol monoethyl ether, diethylene glycol monoethyl ether, triethylene glycol dimethyl ether, diethylene glycol monoethyl ether acetate, diethylene glycol, 1-octanol, ethylene glycol, hexylene glycol, diacetone alcohol, furfuryl alcohol, tetrahydrofurfuryl alcohol, propylene glycol, benzyl alcohol, 1,3-butanediol, 1,4-butanediol, 2,3-butanediol, γ-butyrolactone, acetone, methyl ethyl ketone, methyl isopropyl ketone, diethyl ketone, methyl isobutyl ketone, methyl n-butyl ketone, cyclohexanone, 2-heptanone, ethyl acetate, isopropyl acetate, n-propyl acetate, isobutyl acetate, n-butyl acetate, ethyl lactate, methanol, ethanol, isopropanol, tert-butanol, allyl alcohol, n-propanol, 2-methyl-2-butanol, isobutanol, n-butanol, 2-methyl-1-butanol, 1-pentanol, 2-methyl-1-pentanol, 2-ethylhexanol, trimethylene glycol, 1-methoxy-2-butanol, isopropyl ether, 1,4-dioxane, N,N-dimethylformamide, N,N-dimethylacetamide, N-methyl-2-pyrrolidone, 1,3-dimethyl-2-imidazolidinone, dimethylsulfoxide, and N-cyclohexyl-2-pyrrolidine, and the solvent is not particularly limited so long as the solvent can control the viscosity of the imprint material for forming the structure of the present invention.

<Other Additives>

The imprint material for forming the structure of the present invention may also contain, so long as the effects of the present invention are not impaired, if necessary, an epoxy compound, a photoacid generator, a photosensitizer, an ultraviolet absorber, an antioxidant, an adhesion assistant, or a mold release property improver.

Examples of the epoxy compound include: Epolead (registered trademark) GT-401 and PB3600; Celloxide (registered trademark) 2021P, 2000, 3000; EHPE3150, and EHPE3150CE; and Cyclomer (registered trademark) M100 (manufactured by Daicel Corporation); and EPICLON (registered trademark) 840, 840-S, N-660, and N-673-80M (manufactured by DIC Corporation).

Examples of the photoacid generator include IRGACURE (registered trademark) PAG 103, PAG 108, PAG 121, PAG 203, and CGI 725 (manufactured by BASF Japan Ltd.); WPAG-145, WPAG-170, WPAG-199, WPAG-281, WPAG-336, and WPAG-367 (manufactured by Wako Pure Chemical Industries, Ltd.); and TFE Triazine, TME-Triazine, MP-Triazine, Dimethoxy-triazine, TS-91, and TS-01 (manufactured by Sanwa Chemical Co., Ltd.).

Examples of the photosensitizer include a thioxanthene-based photosensitizer, a xanthene-based photosensitizer, a ketone-based photosensitizer, a thiopyrylium-salt-based photosensitizer, a base-styryl-based photosensitizer, a merocyanine-based photosensitizer, a 3-substituted-coumarin-based photosensitizer, a 3,4-substituted-coumarin-based photosensitizer, a cyanine-based photosensitizer, an acridine-based photosensitizer, a thiazine-based photosensitizer, a phenothiazine-based photosensitizer, an anthracene-based photosensitizer, a coronene-based photosensitizer, a benzanthracene-based photosensitizer, a perylene-based photosensitizer, a ketocoumarin-based photosensitizer, coumarin-based photosensitizer, and a borate-based photosensitizer,

These photosensitizers may be used individually or in combination of two or more types thereof. By using the photosensitizer, the absorption wavelength in the UV region can also be controlled.

Examples of the ultraviolet absorber include TINUVIN (registered trademark) PS, 99-2, 109, 328, 384-2, 400, 405, 460, 477, 479, 900, 928, 1130, 111FDL, 123, 144, 152, 292, 5100, 400-DW, 477-DW, 99-DW, 123-DW, 5050, 5060, and 5151 (manufactured by BASF Japan Ltd.).

These ultraviolet absorbers may be used individually or in combination of two or more types thereof. By using the ultraviolet absorber, the curing rate of the outermost surface of the film during the photocuring of the film can be controlled and, in some cases, the mold release properties of the film can be improved.

Examples of the antioxidant include IRGANOX (registered trademark) 1010, 1035, 1076, 1135, and 1520L (manufactured by BASF Japan Ltd.).

These antioxidants may be used individually or in combination of two or more types thereof. The antioxidant can prevent the film from being discolored to yellow due to the oxidation.

Examples of the adhesion assistant include 3-methacryloxypropyltrimethoxysilane and 3-acryloxypropyltrimethoxysilane. By using the adhesion assistant, the adhesion of the film to the substrate is improved. The content of the adhesion assistant is preferably 5 phr to 50 phr and more preferably 10 phr to 50 phr, based on the mass of the above-described component (A) or the total mass of the component (A) and the above-described component (D).

Examples of the mold release property improver include fluorine-containing compounds and examples of the fluorine-containing compound include R-5410, R-1420, M-5410, M-1420, E-5444, E-7432, A-1430, and A-1630 (manufactured by DAIKIN INDUSTRIES, Ltd.).

<Preparation of Imprint Material>

Although the preparation method of the imprint material for forming the structure of the present invention is not particularly limited, it is satisfactory as the preparation method that at least one compound having in a molecule thereof, one to ten polymerizable group(s), a photopolymerization initiator, a silicone compound that is an optional component, a surfactant, a solvent, and if desired, other additives are mixed to prepare the imprint material, and the resultant mixture as the imprint material is in a homogeneous state.

When at least one compound having in a molecule thereof, one to ten polymerizable group(s), a photopolymerization initiator, a silicone compound, a surfactant, a solvent, and if desired, other additives are mixed, the order of mixing these components is not particularly limited so long as a homogeneous imprint material can be obtained. Examples of the preparation method of the imprint material include a method in which a photopolymerization initiator is mixed with at least one compound having in a molecule thereof, one to ten polymerizable group(s) in a prescribed ratio. The examples include also a method in which further a silicone compound, a surfactant, and a solvent are mixed with the mixture in the above-exemplified first method to prepare a homogeneous imprint material. Further, the examples include also a method in which in an appropriate step of the above-exemplified second method, if necessary, other additives are further added to the mixture in the above-exemplified second method.

A semiconductor device comprising the structure of the present invention and an optical member, a solid-state imaging device, an LED device, a solar battery, and a display comprising the structure of the present invention on a substrate, are also the target of the present invention.

### EXAMPLES

Hereinafter, the present invention is described in more detail with reference to Examples and Comparative Examples, but is not limited to these Examples.

### Synthesis Example 1

Into a flask of 500 mL-volume equipped with a stirrer, a thermometer, and a condenser, 60.8 parts by mass of toluene and 8.4 parts by mass of stearyl alcohol (NAA-46; manufactured by NIPPON OIL AND FAT Co., Ltd., hydroxyl value: 207) were charged and the temperature of the inside of the flask was elevated to 40° C. Then, it was confirmed that stearyl alcohol was completely dissolved and into the flask, 50 parts by mass of an isocyanate-modified type of hexamethylene diisocyanate (TAKENATE (registered trademark) D-170N; manufactured by Mitsui Chemicals, Inc., NCO %: 20.9) was charged, followed by elevating the temperature of the inside of the flask to 70° C. At the same temperature, the reaction was effected for 30 minutes and into the flask, 0.02 part by mass of dibutyltin laurate was charged, followed by keeping the temperature of the inside of the flask at the same temperature for 3 hours. Then, 83.5 parts by mass of polycaprolactone-modified hydroxyethyl acrylate (Praccel (registered trademark) FA2D; manufactured by Daicel Corporation, hydroxyl value: 163), 0.02 part by mass of dibutyltin laurate, and 0.02 part by mass of hydroquinone monomethyl ether were charged into the flask and the temperature of the inside of the flask was kept at 70° C. for 3 hours, followed by terminating the reaction. From the reaction mixture, toluene was removed using an evaporator to obtain a urethane acrylate (I) having a solid content of 100% by mass.

### Synthesis Example 2

Into a flask that is the same as that used in Synthesis Example 1, 48.2 parts by mass of toluene and 4.2 parts by mass of stearyl alcohol (NAA-46) were charged and the temperature of the inside of the flask was elevated to 40° C.

Then, it was confirmed that stearyl alcohol was completely dissolved and into the flask, 25 parts by mass of an isocyanate-modified type of hexamethylene diisocyanate (TAKENATE (registered trademark) D-170N) was charged, followed by elevating the temperature of the inside of the flask to 70° C.

At the same temperature, the reaction was effected for 30 minutes and into the flask, 0.02 part by mass of dibutyltin laurate was charged, followed by keeping the temperature of the inside of the flask at the same temperature for 3 hours.

Then, 83.3 parts by mass of polycaprolactone-modified hydroxyethyl acrylate (Praccel (registered trademark) FA5; manufactured by Daicel Corporation, hydroxyl value: 81.8), 0.02 part by mass of dibutyltin laurate, and 0.02 part by mass of hydroquinone monomethyl ether were charged into the flask and the temperature of the inside of the flask was kept at 70° C. for 3 hours, followed by terminating the reaction. From the reaction mixture, toluene was removed using an evaporator to obtain a urethane acrylate (II) having a solid content of 100% by mass.

### Synthesis Example 3

Into a flask that is the same as that used in Synthesis Example 1, 44.8 parts by mass of toluene and 4.6 parts by mass of stearyl alcohol (NAA-46) were charged and the temperature of the inside of the flask was elevated to 40° C.

Then, it was confirmed that stearyl alcohol was completely dissolved and into the flask, 50 parts by mass of a trimethylol propane adduct-modified type of xylylene diisocyanate (TAKENATE (registered trademark) D-110N; manufactured by Mitsui Chemicals, Inc., solid content: 75%, NCO %: 11.5) was charged, followed by elevating the temperature of the inside of the flask to 70° C.

At the same temperature, the reaction was effected for 30 minutes and into the flask, 0.02 part by mass of dibutyltin laurate was charged, followed by keeping the temperature of the inside of the flask at the same temperature for 3 hours.

Then, 91.7 parts by mass of polycaprolactone-modified hydroxyethyl acrylate (Praccel (registered trademark) FA5), 0.02 part by mass of dibutyltin laurate, and 0.02 part by mass of hydroquinone monomethyl ether were charged into the flask and the temperature of the inside of the flask was kept at 70° C. for 3 hours, followed by terminating the reaction. From the reaction mixture, toluene was removed using an evaporator to obtain a urethane acrylate (III) having a solid content of 100% by mass.

### Synthesis Example 4

Into a flask that is the same as that used in Synthesis Example 1, 61.3 parts by mass of toluene and 9.7 parts by mass of behenyl alcohol (NAA-422; manufactured by NIPPON OIL AND FAT Co., Ltd., hydroxyl value: 180) were charged and the temperature of the inside of the flask was elevated to 40° C.

Then, it was confirmed that behenyl alcohol was completely dissolved and into the flask, 50 parts by mass of an isocyanate-modified type of hexamethylene diisocyanate (TAKENATE (registered trademark) D-170N) was charged, followed by elevating the temperature of the inside of the flask to 70° C.

At the same temperature, the reaction was effected for 30 minutes and into the flask, 0.02 part by mass of dibutyltin laurate was charged, followed by keeping the temperature of the inside of the flask at the same temperature for 3 hours.

Then, 83.4 parts by mass of polycaprolactone-modified hydroxyethyl acrylate (Praccel (registered trademark) FA2D), 0.02 part by mass of dibutyltin laurate, and 0.02 part by mass of hydroquinone monomethyl ether were charged into the flask and the temperature of the inside of the flask was kept at 70° C. for 3 hours, followed by terminating the reaction. From the reaction mixture, toluene was removed using an evaporator to obtain a urethane acrylate (IV) having a solid content of 100% by mass.

[Preparation of Imprint Material]

### Preparation Example 1

To 5 g of the urethane acrylate (I) produced in Synthesis Example 1, 0.125 g (2.5 phr, based on the mass of the urethane acrylate (I)) of Lucirin (registered trademark) TPO (manufactured by BASF Japan Ltd.) (hereinafter, abbreviated as “Lucirin TPO”) was added to prepare an imprint material PNI-1.

### Preparation Example 2

In the same manner as in Preparation Example 1, except that the urethane acrylate (I) used in Preparation Example 1 was changed to the urethane acrylate (II) obtained in Synthesis Example 2, an imprint material PNI-2 was prepared.

### Preparation Example 3

In the same manner as in Preparation Example 1, except that the urethane acrylate (I) used in Preparation Example 1 was changed to the urethane acrylate (III) obtained in Synthesis Example 3, an imprint material PNI-3 was prepared.

### Preparation Example 4

In the same manner as in Preparation Example 1, except that the urethane acrylate (I) used in Preparation Example 1 was changed to the urethane acrylate (IV) obtained in Synthesis Example 4, an imprint material PNI-4 was prepared.

### Preparation Example 5

In the same manner as in Preparation Example 1, except that the urethane acrylate (I) used in Preparation Example 1 was changed to UA-7100 (manufactured by Shin Nakamura Chemical Co., Ltd.), an imprint material PNI-5 was prepared.

### Preparation Example 6

In the same manner as in Preparation Example 1, except that the urethane acrylate (I) used in Preparation Example 1 was changed to NK economer A-1000PER (hereinafter, abbreviated as “A-1000PER”) (manufactured by Shin Nakamura Chemical Co., Ltd.), an imprint material PNI-6 was prepared.

### Preparation Example 7

In the same manner as in Preparation Example 1, except that the urethane acrylate (I) used in Preparation Example 1 was changed to X-22-1602 (manufactured by Shin-Etsu Chemical Co., Ltd.), an imprint material PNI-7 was prepared.

### Preparation Example 8

In the same manner as in Preparation Example 1, except that the urethane acrylate (I) used in Preparation Example 1 was changed to FANCRYL (registered trademark) FA-023M (manufactured by Hitachi Chemical Co., Ltd.), an imprint material PNI-8 was prepared.

### Preparation Example 9

In the same manner as in Preparation Example 1, except that the urethane acrylate (I) used in Preparation Example 1 was changed to NK ester APG-700 (hereinafter, abbreviated as “APG-700”) (manufactured by Shin Nakamura Chemical Co., Ltd.), an imprint material PNI-9 was prepared.

### Preparation Example 10

In the same manner as in Preparation Example 1, except that the urethane acrylate (I) used in Preparation Example 1 was changed to NK ester ATM-35E (manufactured by Shin Nakamura Chemical Co., Ltd.), an imprint material PNI-10 was prepared.

### Preparation Example 11

In the same manner as in Preparation Example 1, except that the urethane acrylate (I) used in Preparation Example 1 was changed to NK ester A-TMPT-9EO (manufactured by Shin Nakamura Chemical Co., Ltd.), an imprint material PNI-11 was prepared.

### Preparation Example 12

In the same manner as in Preparation Example 1, except that the urethane acrylate (I) used in Preparation Example 1 was changed to tetraethylene glycol diacrylate (manufactured by Tokyo Chemical Industry Co., Ltd.), an imprint material PNI-12 was prepared.

### Preparation Example 13

In the same manner as in Preparation Example 1, except that the urethane acrylate (I) used in Preparation Example 1 was changed to KAYARAD (registered trademark) DPEA-12 (hereinafter, abbreviated as “DPEA-12” in the present specification) (manufactured by Nippon Kayaku Co., Ltd.), an imprint material PNI-13 was prepared.

### Preparation Example 14

In the same manner as in Preparation Example 1, except that the urethane acrylate (I) used in Preparation Example 1 was changed to NK ester A-TMPT-3EO (manufactured by Shin Nakamura Chemical Co., Ltd.), an imprint material PNI-14 was prepared.

### Preparation Example 15

In the same manner as in Preparation Example 1, except that the urethane acrylate (I) used in Preparation Example 1 was changed to NK ester A-DCP (manufactured by Shin Nakamura Chemical Co., Ltd.), an imprint material PNI-15 was prepared.

### Preparation Example 16

2.5 g of NK ester AM-90G (hereinafter, abbreviated as “AM-90G”)(manufactured by Shin Nakamura Chemical Co., Ltd.) and 2.5 g of NK ester A-TMPT (hereinafter, abbreviated as “A-TMPT” in the present specification)(manufactured by Shin Nakamura Chemical Co., Ltd.) were mixed. To the mixture, 0.125 g (2.5 phr, based on the total mass of AM-90G and A-TMPT) of Lucirin TPO was added to prepare an imprint material PNI-16.

### Preparation Example 17

2.5 g of DPEA-12 and 2.5 g of the urethane acrylate (I) obtained in Synthesis Example 1 were mixed. To the mixture, 0.125 g (2.5 phr, based on the total mass of DPEA-12 and the urethane acrylate (I)) of Lucirin TPO was added to prepare an imprint material PNI-17.

### Preparation Example 18

In the same manner as in Preparation Example 17, except that the urethane acrylate (I) used in Preparation Example 17 was changed to the urethane acrylate (II) obtained in Synthesis Example 2, an imprint material PNI-18 was prepared.

### Preparation Example 19

In the same manner as in Preparation Example 17, except that the urethane acrylate (I) used in Preparation Example 17 was changed to the urethane acrylate (III) obtained in Synthesis Example 3, an imprint material PNI-19 was prepared.

### Preparation Example 20

In the same manner as in Preparation Example 17, except that the urethane acrylate (I) used in Preparation Example 17 was changed to the urethane acrylate (IV) obtained in Synthesis Example 4, an imprint material PNI-20 was prepared.

### Preparation Example 21

2.5 g of KAYARAD (registered trademark) DPHA (hereinafter, abbreviated as “DPHA”) and 2.5 g of A-1000PER were mixed. To the mixture, 0.125 g (2.5 phr, based on the total mass of DPHA and A1000PER) of Lucirin TPO was added to prepare an imprint material PNI-21.

### Preparation Example 22

2.75 g of DPHA and 2.25 g of A-1000PER were mixed. To the mixture, 0.125 g (2.5 phr, based on the total mass of DPHA and A1000PER) of Lucirin TPO was added to prepare an imprint material PNI-22.

### Preparation Example 23

3.0 g of DPHA and 2.0 g of A-1000PER were mixed. To the mixture, 0.125 g (2.5 phr, based on the total mass of DPHA and A1000PER) of Lucirin TPO was added to prepare an imprint material PNI-23.

### Preparation Example 24

0.25 g of DPHA, 1.75 g of UA-306H (manufactured by KYOEISHA CHEMICAL Co., LTD.), and 3.0 g of A-1000PER were mixed. To the mixture, 0.125 g (2.5 phr, based on the total mass of DPHA, UA-306H, and A1000PER) of Lucirin TPO was added to prepare an imprint material PNI-24.

### Preparation Example 25

0.5 g of DPEA-12, 2.0 g of A-TMPT, and 2.5 g of A-1000PER were mixed. To the mixture, 0.125 g (2.5 phr, based on the total mass of DPEA-12, A-TMPT and A1000PER) of Lucirin TPO was added to prepare an imprint material PNI-25.

### Preparation Example 26

0.5 g of DPEA-12, 2.0 g of UA-306H, 2.5 g of A-1000PER, and 0.05 g (1 phr, based on the total mass of DPEA-12, UA-306H, and A-1000PER) of BYK-333 (manufactured by BYK Japan KK) were mixed and to the resultant mixture, 0.125 g (2.5 phr, based on the total mass of DPEA-12, UA-306H, and A1000PER) of Lucirin TPO was added to prepare an imprint material PNI-26.

### Preparation Example 27

0.5 g of DPEA-12, 2.0 g of UA-306H, and 2.5 g of APG-700 were mixed. To the mixture, 0.125 g (2.5 phr, based on the total mass of DPEA-12, UA-306H and APG-700) of Lucirin TPO was added to prepare an imprint material PNI-27.

### Preparation Example 28

0.5 g of DPEA-12, 2.0 g of DPHA, and 2.5 g of A-1000PER were mixed. To the mixture, 0.125 g (2.5 phr, based on the total mass of DPEA-12, DPHA and A-1000PER) of Lucirin TPO was added to prepare an imprint material PNI-28.

### Preparation Example 29

5 g of NK ester A1000 (hereinafter, abbreviated as “A1000”) (manufactured by Shin Nakamura Chemical Co., Ltd.), 0.125 g (2.5 phr, based on the mass of A1000) of Lucirin TPO, and 5.125 g of methyl ethyl ketone (hereinafter, abbreviated as “MEK”) were mixed to prepare an imprint material PNI-29.

### Preparation Example 30

1.75 g of UA-306H, 3.25 g of X-22-1602, 0.125 g (2.5 phr, based on the total mass of UA-306H and X-22-1602) of Lucirin TPO, and 5.125 g of MEK were mixed to prepare an imprint material PNI-30.

### Preparation Example 31

2.0 g of UA-306H, 3.0 g of X-22-1602, 0.125 g (2.5 phr, based on the total mass of UA-306H and X-22-1602) of Lucirin TPO, and 5.125 g of MEK were mixed to prepare an imprint material PNI-31.

### Preparation Example 32

2.25 g of UA-306H, 2.75 g of X-22-1602, 0.0025 g (0.05 phr, based on the total mass of UA-306H and X-22-1602) of MEGAFAC (registered trademark) F477 (manufactured by DIC Corporation), 0.125 g (2.5 phr, based on the total mass of UA-306H and X-22-1602) of Lucirin TPO, and 5.125 g of MEK were mixed to prepare an imprint material PNI-32.

### Preparation Example 33

5 g of A-TMPT and 0.125 g (2.5 phr, based on the mass of A-TMPT) of Lucirin TPO were mixed to prepare an imprint material PNI-33.

### Preparation Example 34

5 g of KAYARAD PET30 (hereinafter, abbreviated as “PET30”) (manufactured by Nippon Kayaku Co., Ltd.) and 0.125 g (2.5 phr, based on the mass of PET30) of Lucirin TPO were mixed to prepare an imprint material PNI-34.

### Preparation Example 35

5 g of UA-510 (manufactured by KYOEISHA CHEMICAL Co., LTD.) and 0.125 g (2.5 phr, based on the mass of UA-510) of Lucirin TPO were mixed to prepare an imprint material PNI-35.

### Preparation Example 36

3.25 g of DPHA, 1.75 g of A-1000PER, and 0.125 g (2.5 phr, based on the total mass of DPHA and A-1000PER) of Lucirin TPO were mixed to prepare an imprint material PNI-36.

### Preparation Example 37

3.5 g of DPHA, 1.5 g of A-1000PER, and 0.125 g (2.5 phr, based on the total mass of DPHA and A-1000PER) of Lucirin TPO were mixed to prepare an imprint material PNI-37.

[Mold Release Treatment of Mold]

A nickel moth-eye pattern mold (manufactured by InnoX Co., Ltd.) having a cycle of 250 nm and a height of 250 nm and a silicon wafer were immersed in a solution prepared by diluting OPTOOL (registered trademark) DSX (manufactured by DAIKIN INDUSTRIES, Ltd.) with Novec (registered trademark) HFE-7100 (hydrofluoroether, manufactured by Sumitomo 3M Limited) (hereinafter, abbreviated as “Novec HFE-7100” in the present specification) to 0.1% by mass. The mold and the silicon wafer were subjected to a treatment using a high temperature-high humidity apparatus set to a temperature of 90° C. and a humidity of 90 RH % for 1 hour. Then, the mold and the silicon wafer were rinsed with Novec HFE-7100 and were dried with air.

[Optical Imprint and Test for Mold Release Force]

Each of the imprint materials obtained in Preparation Example 1 to Preparation Example 37 was applied onto a triacetyl cellulose film (FUJITAC (registered trademark) manufactured by FUJIFILM Corporation was used) (hereinafter, abbreviated as “TAC film”) having a thickness of 80 μm using a bar coater (full-automatic film applicator, KT-AB3120, manufactured by COTEC Corporation), and the resultant coating film on the TAC film was pressed into the moth-eye pattern mold subjected to the mold release treatment using a roller. Next, the coating film was irradiated with light from the TAC film side using an electrodeless uniform irradiation device (QRE-4016A, manufactured by ORC MANUFACTURING CO., LTD.) to be exposed to light with an exposure amount of 350 mJ/cm² and was photocured. Then, the coating film was subjected to a 90° peeling test referring to JIS Z0237, such that a load applied to the coating film that was formed on the TAC film and was adhering to the concave-convex shaped face of the mold was measured when the coating film was completely peeled from the concave-convex shaped face of the mold. Based on the measured load, the load per cm of the width of the film was calculated to obtain the mold release force (g/cm). The results are shown in Table 1 and Table 2.

[Wiping-Off Test of Fingerprint]

After the test for the mold release force, a structure to which a moth-eye pattern as a concave-convex shape was transferred was obtained on the TAC film. In the TAC film, a surface on the opposite side of the surface having the structure to which the moth-eye pattern was transferred was painted in black using a super lacquer spray (manufactured by Asahipen Corporation). Then, onto the moth-eye pattern of the structure obtained on the TAC film, an artificial fingerprint liquid (manufactured by TDK Corporation) was applied and Bemcot (registered trademark) M-1 (manufactured by Asahi Kasei Fibers Corporation) was attached to a tester (manufactured by Daiei Seiki Co., Ltd.). Then, a wiping-off test of the fingerprints involving 50 back and forth motions with a load of 570 g/cm² was performed, and wiping-off properties relative to the fingerprints were visually confirmed. The wiping-off method used in the test was dry-wipe-off. After the wiping-off test, when the fingerprints were able to be dry-wiped off the structure, it was evaluated as “◯” and when the fingerprints were not able to be dry-wiped off the structure, that is, the fingerprints remained, it was evaluated as “X”. The results of the evaluation are shown in Table 1 and Table 2.

[Measurement of Martens Hardness]

Each of the imprint materials obtained in Preparation Example 1 to Preparation Example 37 was applied onto a quartz substrate using a bar coater (full-automatic film applicator, KT-AB3120, manufactured by COTEC Corporation), and the resultant coating film on the quartz substrate was pressed into the silicon wafer subjected to the mold release treatment using a roller. Next, the coating film was irradiated with light from the quartz substrate side using an electrodeless uniform irradiation device (QRE-4016A, manufactured by ORC MANUFACTURING CO., LTD.) to be exposed to light with an exposure amount of 350 mJ/cm² and was photocured. Then, the silicon wafer was peeled from the quartz substrate and the Martens hardness of the obtained cured film was measured using as the measuring apparatus, an ultramicro indentation hardness tester ENT-2100 (manufactured by ELIONIX INC.) and using as the indenter, a titanium triangular indenter (manufactured by Tokyo Diamond Tools Mfg. Co., Ltd.) having an intercristal angle of 115° under a condition under which the Martens hardness of a molten quartz is 4,100 N/mm². The results are shown in Table 1 and Table 2.

TABLE 1

| | | | | Mold |
|---|---|---|---|---|
| | | Martens | Fingerprint | release |
| | | hardness | willing-off | force |
| | Imprint material | (N/mm²) | properties | (g/cm) |
| Example 1 | PNI-1 | 13.1 | ∘ | 0.45 |
| Example 2 | PNI-2 | 12.5 | ∘ | 0.52 |
| Example 3 | PNI-3 | 14.3 | ∘ | 0.51 |
| Example 4 | PNI-4 | 12.9 | ∘ | 0.47 |
| Example 5 | PNI-5 | 8.4 | ∘ | 0.42 |
| Example 6 | PNI-6 | 8.3 | ∘ | 0.41 |
| Example 7 | PNI-7 | 9.1 | ∘ | 0.38 |
| Example 8 | PNI-8 | 11.3 | ∘ | 0.43 |
| Example 9 | PNI-9 | 13.2 | ∘ | 0.48 |
| Example 10 | PNI-10 | 14.1 | ∘ | 0.50 |
| Example 11 | PNI-11 | 26.3 | ∘ | 0.56 |
| Example 12 | PNI-12 | 58.9 | ∘ | 0.62 |
| Example 13 | PNI-13 | 80.4 | ∘ | 0.80 |
| Example 14 | PNI-14 | 125.8 | ∘ | 1.0 |
| Example 15 | PNI-15 | 126.4 | ∘ | 0.95 |
| Example 16 | PNI-16 | 71.7 | ∘ | 0.67 |
| Example 17 | PNI-17 | 32.0 | ∘ | 0.45 |
| Example 18 | PNI-18 | 34.0 | ∘ | 0.40 |
| Example 19 | PNI-19 | 37.2 | ∘ | 0.50 |
| Example 20 | PNI-20 | 37.0 | ∘ | 0.41 |
| Example 21 | PNI-21 | 93.9 | ∘ | 0.86 |
| Example 22 | PNI-22 | 107.9 | ∘ | 0.91 |
| Example 23 | PNI-23 | 120.0 | ∘ | 0.96 |
| Example 24 | PNI-24 | 57.8 | ∘ | 0.63 |
| Example 25 | PNI-25 | 61.6 | ∘ | 0.69 |

TABLE 2

| | | | | Mold |
|---|---|---|---|---|
| | | Martens | Fingerprint | release |
| | | hardness | wiping-off | force |
| | Imprint material | (N/mm²) | properties | (g/cm) |
| Example 26 | PNI-26 | 65.8 | ∘ | 0.31 |
| Example 27 | PNI-27 | 69.0 | ∘ | 1.30 |
| Example 28 | PNI-28 | 76.5 | ∘ | 0.81 |
| Example 29 | PNI-29 | 9.9 | ∘ | 0.38 |
| Example 30 | PNI-30 | 39.1 | ∘ | 0.37 |
| Example 31 | PNI-31 | 46.3 | ∘ | 0.48 |
| Example 32 | PNI-32 | 52.9 | ∘ | 0.46 |
| Comparative | PNI-33 | 196.5 | x | 2.1 |
| Example 1 | | | | |
| Comparative | PNI-34 | 205.1 | x | 3.3 |
| Example 2 | | | | |
| Comparative | PNI-35 | 200.4 | x | 3.12 |
| Example 3 | | | | |
| Comparative | PNI-36 | 137.8 | x | 1.31 |
| Example 4 | | | | |
| Comparative | PNI-37 | 159 | x | 1.72 |
| Example 5 | | | | |

According to the results in Table 1 and Table 2, the fingerprints were able to be dry-wiped off any one of the structures of Example 1 to Example 32 fabricated using the imprint materials PNI-1 to PNI-32. In contrast, with respect to any one of the structures of Comparative Example 1 to Comparative Example 5 fabricated using the imprint materials PNI-33 to PNI-37, after the wiping-off test of the fingerprint, the fingerprints remained, so that the fingerprints were not able to be dry-wiped off any one of the structures of Comparative Example 1 to Comparative Example 5.

### INDUSTRIAL APPLICABILITY

Fingerprints attached to the concave-convex shaped surface of the structure can be dry-wiped off the structure of the present invention. Therefore, for example, the structure can be suitably applied to the surface of a display, a solar battery, or a LED device.

1. A structure having a concave-convex shaped surface, fabricated from a composition containing at least one compound having in a molecule, one to ten polymerizable group(s) and a photopolymerization initiator, wherein
the structure has a Martens hardness of 3 N/mm² or more and 130 N/mm² or less when the Martens hardness of the structure is measured under a condition under which a Martens hardness of a molten quartz is 4,100 N/mm².

2. The structure according to claim 1, wherein
the polymerizable group is at least one selected from the group consisting of an acryloyloxy group, a methacryloyloxy group, a vinyl group, and an allyl group.

3. The structure according to claim 1, fabricated by imprinting the composition further containing a silicone compound.

4. The structure according to claim 3, wherein
the silicone compound is a compound of Formula (1) or Formula (2): 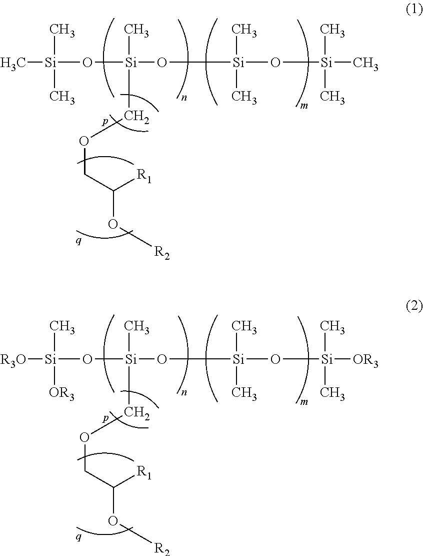
(in Formulae (1) and (2), R₁ is a hydrogen atom or a methyl group; R₂ is a hydrogen atom or a C₁₋₅ alkyl group; a plurality of R₃s are each independently a hydrogen atom or a C₁₋₃ alkyl group; n is an integer of 1 to 55; m is an integer of 0 to 97; p is an integer of 1 to 5; and q is an integer of 1 to 10).

5. The structure according to claim 1, wherein
the concave-convex shape is a moth-eye structure.

6. A method for producing the structure as claimed in claim 1, comprising:
applying the composition containing at least one compound having in a molecule, one to ten polymerizable group(s) and a photopolymerization initiator onto a substrate;
pressing a coating film on the substrate into a concave-convex shaped face of a mold;
photocuring the coating film while it is pressed into the concave-convex shaped face of the mold; and
peeling the cured film on the substrate from the mold.

7. The method for producing the structure according to claim 6, wherein
the composition further contains a surfactant.

8. The method for producing the structure according to claim 6, comprising:
applying the composition further containing a solvent onto the substrate and then baking the composition to evaporate the solvent.

9. The method for producing the structure according to claim 6, wherein
as the substrate, a film is used, and
in a test in which the cured film on the film is peeled from the mold at 90°, a mold release force that is a value obtained by converting a load applied to the cured film on the film when the cured film is peeled from the mold into a load per cm of the width of the film, is larger than 0 g/cm and 0.7 g/cm or smaller.

10. An optical member comprising:
the structure as claimed in claim 1 on a substrate.

11. A solid-state imaging device comprising:
the structure as claimed in claim 1 on a substrate.

12. An LED device comprising:
the structure as claimed in claim 1 on a substrate.

13. A semiconductor device comprising:
the structure as claimed in claim 1 on a substrate.

14. A solar battery comprising:
the structure as claimed in claim 1 on a substrate.

15. A display comprising:
the structure as claimed in claim 1 on a substrate.

16. An electronic device comprising:
the structure as claimed in claim 1 on a substrate.
